(19) United States
(12) Patent Application Publication
(10) Pub. No.: US 2004/0132425 A1
(43) Pub. Date: Jul. 8, 2004

(54) Method for increasing using time of a battery of a mobile station in a communication system

(75) Inventors: Woo Sok Kang, Seoul (KR); Byung Yup Kim, Busan (KR); Young Jo Lee, Gyeonggi-do (KR)

Correspondence Address: FLESHNER & KIM, LLP, P.O. BOX 221200, CHANTILLY, VA, 20153, US

(73) Assignee: LG Electronics Inc.

(21) Appl. No.: 10/714,621

(22) Filed: Nov. 18, 2003

(30) Foreign Application Priority Data
Dec. 11, 2002 (KR) 10-2002-0078842

(51) Int. Cl. H04B 1/16

(52) U.S. Cl. 455/343.1

(57) ABSTRACT

A method for reducing battery consumption of mobile stations sets retrieval periods of a paging channel to different ones according to uses of the mobile stations. One embodiment includes setting slot cycle index values for deciding retrieval periods of the mobile stations to different values according to uses of the mobile stations. Another embodiment includes setting the retrieval period of a paging channel according to uses of mobile stations, registering the set retrieval period to an upper system, and retrieving the slots of the paging channel as each mobile station transitions from a sleep state to an active state in the registered retrieval period. For a mobile station which is not required to receive paging messages in real-time such as a mobile station for tracing a position and a mobile station for dedicatedly transmitting a character message, the retrieval period of the slots of the paging channel is set to be long, thereby increasing the sleep time of the mobile station and thereby reducing battery consumption.

### BACKGROUND OF THE INVENTION

1. Field of the Invention

The present invention generally relates to mobile communications, and more particularly to a system and method for increasing the use time of a battery of a mobile station (MS) in a mobile communication system.

2. Background of the Related Art

Mobile service providers traditionally provide service such that all mobile stations have a same retrieval period of slots of a paging channel (hereinafter, referred to as “retrieval period”). That is, in all mobile stations, slot cycle index values, which are a factor of deciding the retrieval period of the mobile station, are all set to a same value. Each MS transitions from a sleep state to an active state according to the slot cycle index value, thereby retrieving paging messages transmitted to itself.

FIG. 1 shows a retrieval period used by many related-art mobile stations. As shown in this figure, it is common to provide services by setting a slot cycle index value of the MSs to ‘2’. Accordingly, each MS retrieves slots allocated to itslef with 64 slot periods. The slot cycle index value is set as one positive number between 0 to 7. When the index value is 0, the MS retrieves the slots with 16 retrieval periods. When the index value is 1, the MS retrieves the slots with 32 retrieval periods.

As mentioned above, the related-art mobile stations are all set to have a same retrieval period Accordingly, the on-time of an active state for each mobile station is also same and thus battery consumption is proportionally decreased. Accordingly, for a MS which is not required to receive paging messages in real-time (such as a MS for tracing a position and a MS for dedicatedly transmitting a character message), the retrieval period is set to an unnecessarily short one, which thereby causes the battery to be unnecessarily consumed.

### SUMMARY OF THE INVENTION

An object of the present invention is to solve one or more of the above-mentioned problems of the related art.

Another object of the present invention is to reduce unnecessary battery consumption by setting different retrieval periods of mobile stations according to use, thereby increasing a sleep time of the MS.

In order to accomplish these and other objects and advantages, the present invention provides a method for increasing the use time of a battery of a mobile station in a communication system, comprising the processes of identifying the mobile stations according to the uses thereof; setting a slot cycle index value of each MS according to the uses; and retrieving slots of a paging channel in the corresponding MS according to the slot cycle index value. The slot cycle index value is preferably a positive number of 0 to 7.

Preferably, the process of setting the slot cycle index value comprises the steps of deciding the slot cycle index value in the MS, thereby transmitting it to an upper system; and storing the slot cycle index value into a slot cycle index field of a retrieval period information table for the respective MS in the upper system.

Differently, the process of setting the slot cycle index value may comprise the steps of deciding the slot cycle index value in an upper system, thereby transmitting it to the MS; reporting a receipt of the slot cycle index value to an user in the MS; setting the received slot cycle index value when a message of changing a retrieval period is inputted from the user; reporting a completion of setting the slot cycle index value to the upper system; and storing the slot cycle index value into a slot cycle index field of a retrieval period information table for the respective MS in the upper system. Preferably, the slot cycle index value is stored in a certain filed of an order message, and then transmitted to the MS.

Preferably, the process of retrieving the slots of the paging channel comprises the steps of setting the slot cycle index value that is periodically transmitted to the MS from the upper system as a maximum value; comparing the slot cycle index value received from the upper system with the set slot cycle index value, thereby choosing a more smaller value; and retrieving the slots of the paging channel as the MS is transitioned from a sleep state to an active state according to the chosen slot cycle index value.

According to another embodiment of the invention, there is provided a method for increasing using time of a battery of a MS in a communication system, comprising the processes of setting a retrieval period of slots of a paging channel according to the uses of the MS; registering the retrieval period in an upper system; and retrieving the slots of the paging channel as the MS is transitioned from a sleep state to an active state in the registered retrieval period.

Preferably, the process of registering the retrieval period comprises the steps of setting a slot cycle index value corresponding to the retrieval period in the MS; transmitting the set slot cycle index value to the upper system; and storing the slot cycle index value into a slot cycle index field of a retrieval period information table for the respective MS in the upper system.

According to a further embodiment of the invention, there is provided a method for increasing using time of a battery of a MS in a communication system, comprising the processes of identifying the uses of the MS by using a subscriber information of the MS in an upper system; deciding a retrieval period of a paging channel of the MS according to the uses, thereby transmitting it to the MS; setting the retrieval period in the MS; registering the set retrieval period in the upper system; and retrieving the paging channel in the MS as the MS is transitioned from a sleep state to an active state in the registered retrieval period.

Preferably, the process of setting the retrieval period comprises the steps of receiving a message in which a slot cycle index value corresponding to the retrieval period is stored from the upper system; reporting a receipt of the message to an user, and setting the received slot cycle index value when a message of changing the retrieval period is inputted from the user.

Preferably, the process of registering the retrieval period comprises the steps of setting the slot cycle index value corresponding to the received retrieval period in the MS, and then reporting a completion of the setting to the upper system; and storing the slot cycle index value into a slot cycle index field of a retrieval period information table for the respective MS in the upper system.

Preferably, the process of retrieving the paging channel comprises the steps of setting the slot cycle index value that is periodically transmitted to the MS from the upper system as a maximum value; comparing the slot cycle index value received from the upper system with the set slot cycle index value, thereby choosing a more smaller value; and retrieving the slots of the paging channel in the retrieval period.

According to a further embodiment of the invention, there is provided a method for increasing using time of a battery of a MS in a communication system, comprising the processes of identifying the mobile stations according to the uses thereof; and setting slot cycle index values of the mobile stations according to the uses, respectively. The slot cycle index value is preferably a positive number of 0 to 7.

Preferably, the process of identifying the mobile stations according to the uses thereof comprises the process of setting retrieval periods of the slots of the paging channel as different ones, respectively.

Preferably, the retrieval period of the slots of the paging channel is changed according to the slot cycle index value of the mobile station.

More preferably, the method further comprises the process of retrieving the slots of the paging channel in the corresponding mobile station according to the slot cycle index value.

Preferably, the slot cycle index value is comprised in an order message.

### BRIEF DESCRIPTION OF THE DRAWINGS

FIG. 1 is a view of illustratively showing a retrieval period of slots of a paging channel in a related-art MS;

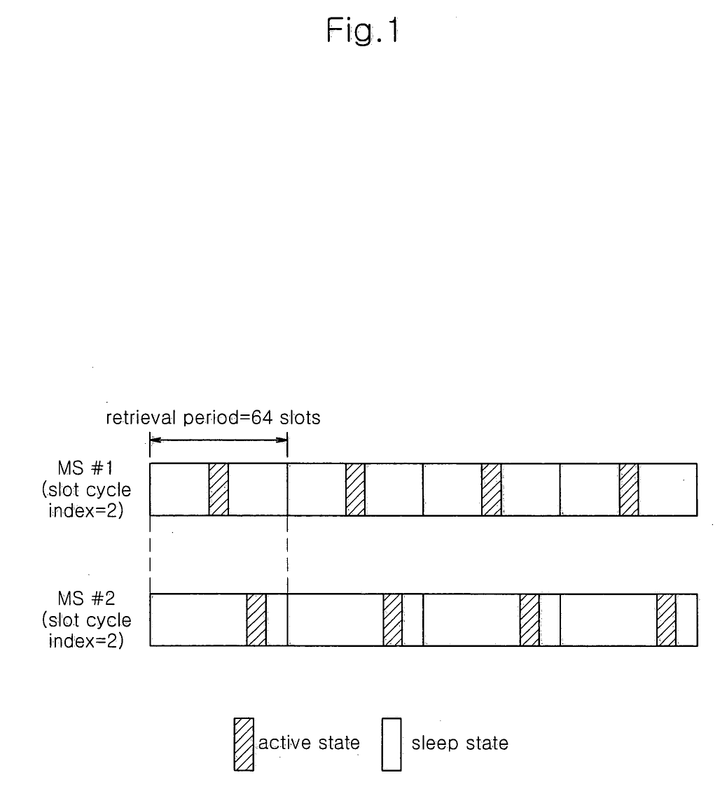

FIG. 2 is a view of showing a message flow when a retrieval period of slots of a paging channel in the MS is set according to the present invention;

FIG. 3 is a view of showing a message flow when a retrieval period of the MS is set in an upper system according to the present invention;

FIG. 4 is a view of illustratively showing a retrieval period of the MS according to the present invention.

### DETAILED DESCRIPTION OF THE PREFERRED EMBODIMENTS

A mobile station operates in a sleep state and transitions to an active state every retrieval period of slots of a paging channel thereof, so that it retrieves the slots allocated to itself, thereby checking a paging message transmitted from an upper system. The MS returns to the sleep state when there is not a paging message transmitted to itself. When a paging message is transmitted to the MS, the MS receives the message and then returns to the sleep state. In this time, while the MS is operating in with the active state, a battery of the MS is consumed.

Accordingly, for an MS which is not required to process paging messages with real-time (such as a MS for servicing a voice call, a MS for tracing a position and a MS for dedicatedly transmitting a character message), a retrieval period thereof is set to be long, which thereby increases the sleep state time. As a result, the battery consumption can be reduced.

According to the present invention, a retrieval period of slots of a paging channel is decided, according to the following equation, by a slot cycle index value present at a code division multiple access system standard, according to the uses of the MS.

an incoming period (msec)=16*2^{slot cycle index value}*80 (msec)

where, 16*2^{slot cycle index value} is the number of slots, the slot cycle index value is a positive number of 0 to 7, and 80 (msec) is a slot period.

Accordingly, each MS may have retrieval periods different from one another by setting an appropriate slot cycle index value according to the uses thereof when initially setting up. For example, by setting the slot cycle index value as ‘4’, an MS for tracing a position monitors a paging channel with a slot period of 16×2⁴ and remains in a sleep state during the corresponding time. As a result, battery consumption can be significantly reduced.

Meanwhile, slot cycle index information, which is a factor of deciding a retrieval period of slots of the paging channel, should be registered in an upper system in order to transmit a paging message to the MS in the retrieval period. For example, the slot cycle index information of the MS should be registered in a mobile switching center (MSC) via a base station (BS).

Accordingly, the MSC has a retrieval period information table for respective MSs, and stores and registers the slot cycle index information of each MS into a slot cycle index field of the table. Meanwhile, the retrieval period information table for the respective MS may be provided for other database system such as a base controller, a home location register (HLR) or a visitor location register (VLR) rather than the MSC.

When transmitting a paging message, the MSC transmits the slot cycle index information of the MS, which was stored in the retrieval period information table for the respective MS, to the base station. Then, the base station transmits the paging message to the MS in the retrieval period of the MS using the slot cycle index information transmitted from the MSC.

The MS transitions from the sleep state to the active state in the retrieval period thereof, so that it receives the paging message transmitted from the upper system. In this time, the MS chooses a smaller one of the slot cycle index values stored in a memory such as an EEPROM. of the MS according to the retrieval period set in itself, the retrieval period transmitted from the upper system, and more specifically, the uses thereof, and a max slot cycle index value periodically transmitted from the upper system via a system parameter message of the paging channel, and thus decides a retrieval period of its own. Accordingly, the upper system sets the max slot cycle index value as a settable maximum value of ‘7’ and transmits it. A method for increasing the use time of a battery of the MS is explained in more detail with reference to the accompanying drawings.

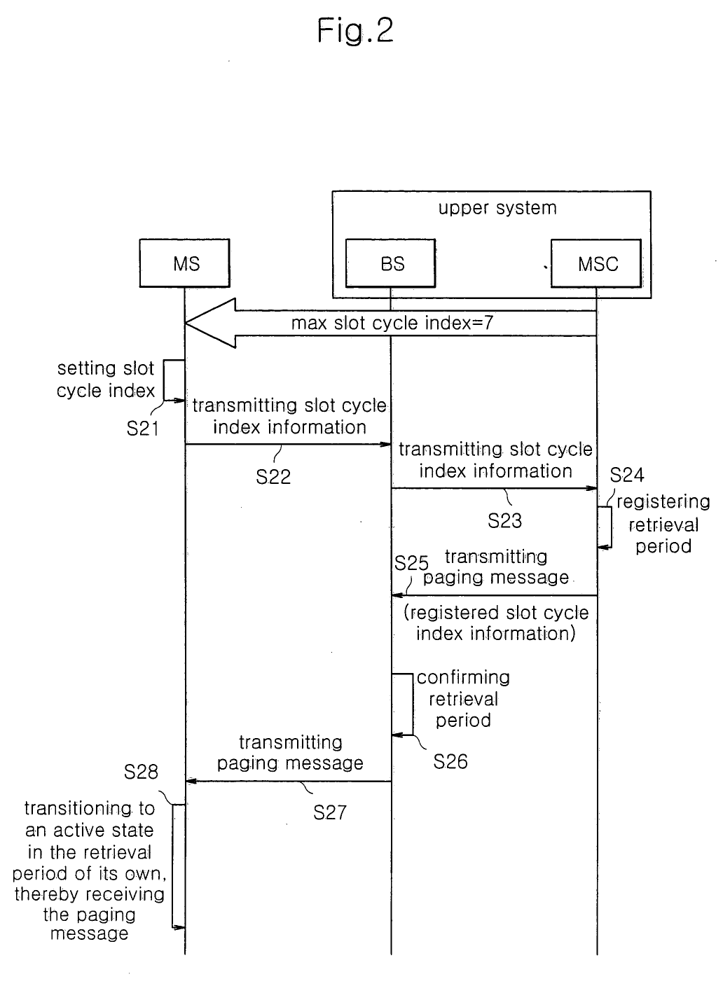

FIG. 2 is a flowchart showing that when the MS periodically receives a max slot cycle index (=7) from the MSC according to an embodiment of the invention, it sets a slot cycle index of its own. The MS sets a slot cycle index value for deciding a retrieval period suitable for the uses thereof (S21). Then, the MS transmits the set slot cycle index information to the MSC via the BS by using a registration message (S22, S23). The MSC stores and registers the transmitted slot cycle index value in a slot cycle index field of a retrieval period information table for the respective MS (S24).

After that, when transmitting the paging message, the MSC transmits the registered slot cycle index information to the BS (S25). The BS confirms the retrieval period of the MS by using the slot cycle index information of the MS (S26), and then transmits the paging message to the MS via slots allocated to the MS in the retrieval period (S27).

Correspondingly, the MS transitions from a sleep state to an active state in the retrieval period of its own, so that it retrieves the slots allocated to itself and thus receives the paging message transmitted from the MSC via the BS (S28).

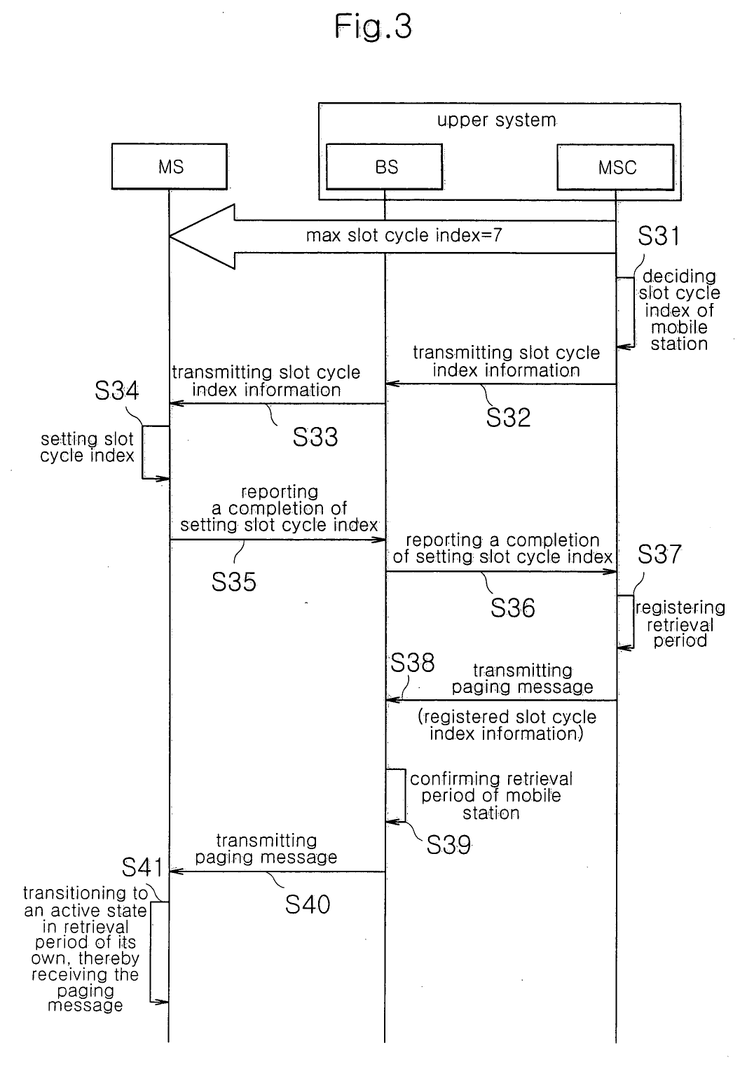

FIG. 3 is a flowchart showing that when the MSC periodically transmits a max cycle index (=7) to the MS according to another embodiment of the invention, it sets a slot cycle index value of the respective MS. The MSC identifies the uses of the corresponding MS by using the subscriber information of the MS and decides a slot cycle index value suitable for the uses (S31). The subscriber information comprises billing information stored in a billing center or registration information stored in the HLR.

The decided slot cycle index information is transmitted to the BS (S32). The BS transmits the slot cycle index information received from the MSC to the corresponding MS through a certain message (S33). The certain message is an order message being transmitted to the corresponding MS via the paging channel. A slot cycle index information field in which the slot cycle index value is set is defined in the message.

The MS which received the slot cycle index information reports receipt of the information to the user, sets the received slot cycle index value when a message of changing a retrieval period is input from the user (S34), and transmits a response message reporting completion of the setting to the MSC via the BS (S35, S36).

Correspondingly, the MSC registers the slot cycle index value set in the corresponding MS, that is, the slot cycle index value that was decided and transmitted by it, into a slot cycle index field of a retrieval period information table for the respective MS (S37).

After that, when transmitting the paging message to the corresponding MS, the MSC transmits the slot cycle index information of the corresponding MS to the BS (S38).

Then, the BS confirms a retrieval period of the corresponding MS using the received slot cycle index information (S39) and transmits the paging message to the MS in the retrieval period (S40).

Correspondingly, the MS transitions from a sleep state to an active state in the retrieval period of its own, so that it retrieves the slots of the paging channel allocated to itself and receives the paging message being transmitted via the BS (S41).

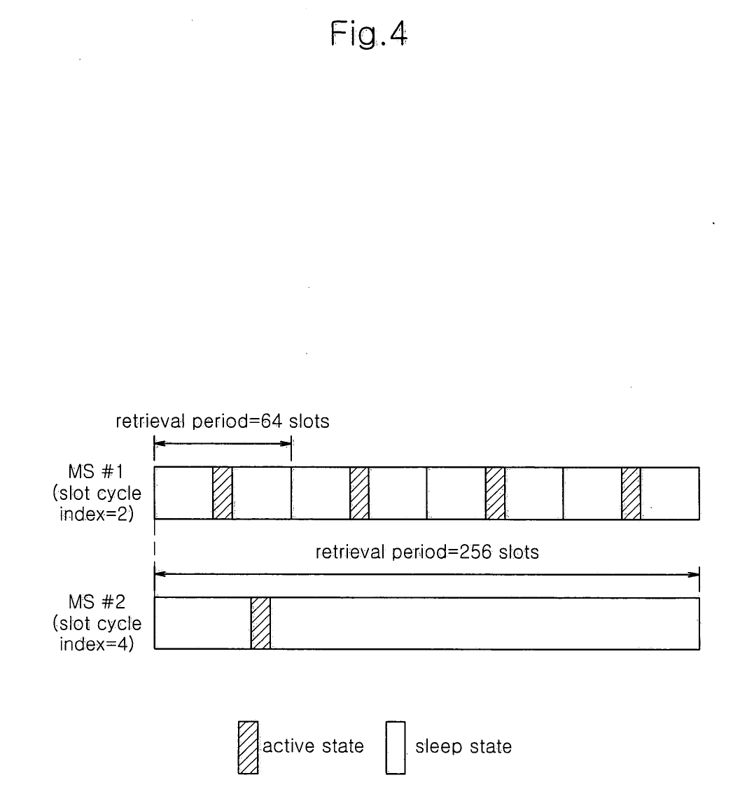

FIG. 4 is a view of illustratively showing a retrieval period of the MS according to the invention. The slot cycle index values are set as different ones according to uses of the MS. The MS having a slot cycle index value of ‘2’ transitions from the sleep state to the active state every 64 (16×2²) slot periods, retrieves the slots of the paging channel allocated to itself, and checks the paging message being transmitted to itself. The MS having a slot cycle index value of ‘4’ transitions to the active state every 256 (16×2⁴) slot periods, retrieves the slots of the paging channel allocated to itself, and checks the paging message.

As discussed above, according to the invention, for a MS which is not required to receive paging messages in real-time, such as a MS for tracing a position and a MS for dedicatedly transmitting a character message, the retrieval period thereof is set to be long by setting the retrieval periods of the slots of the paging channel as different ones according to uses of the MS, thereby increasing the sleep time of the MS. Accordingly, battery consumption can be reduced.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for increasing use time of a battery of a mobile station (MS) of a communication system, comprising:
identifying a plurality of mobile stations based on uses thereof;
setting a slot cycle index value of each of the mobile stations according to the uses; and
retrieving slots of a paging channel in each MS according to the slot cycle index value.

2. The method of claim 1, wherein the slot cycle index value is a positive number of 0 to 7.

3. The method of claim 1, wherein said setting the slot cycle index value comprises:
deciding the slot cycle index value in the MS;
transmitting the slot cycle index value to an upper system; and
storing the slot cycle index value into a slot cycle index field of a retrieval period information table for the MS in the upper system.

4. The method of claim 1, wherein said setting the slot cycle index value comprises:
deciding the slot cycle index value in an upper system;
transmitting the slot cycle index value to the MS;
reporting receipt of the slot cycle index value to a user of the MS;
setting the received slot cycle index value when a message input from the user indicates changes of a retrieval period;
reporting completion of setting the slot cycle index value to the upper system; and
storing the slot cycle index value into a slot cycle index field of a retrieval period information table for the MS in the upper system.

5. The method of claim 4, wherein the slot cycle index value is stored in a certain field of an order message, and then transmitting the message to the MS.

6. The method of claim 1, wherein said retrieving the slots of the paging channel comprises:
setting the slot cycle index value that is periodically transmitted to the MS from the upper system as a maximum value;
comparing the slot cycle index value received from the upper system with the set slot cycle index value and choosing a smaller value; and
retrieving the slots of the paging channel as the MS transitions from a sleep state to an active state according to the chosen slot cycle index value.

7. A method for increasing use time of a battery of a mobile station (MS) of a communication system, comprising:
setting a retrieval period of slots of a paging channel according to a use of the MS;
registering the retrieval period in an upper system; and
retrieving the slots of the paging channel as the MS transitions from a sleep state to an active state in the registered retrieval period.

8. The method of claim 7, wherein said registering the retrieval period comprises:
setting a slot cycle index value corresponding to the retrieval period in the MS;
transmitting the set slot cycle index value to the upper system; and
storing the slot cycle index value into a slot cycle index field of a retrieval period information table for the MS in the upper system.

9. A method for increasing use time of a battery of a mobile station (MS) of a communication system, comprising:
identifying one or more uses of the MS based on a subscriber information of the MS in an upper system;
deciding a retrieval period of a paging channel of the MS according to the uses, and transmitting information indicative of the retrieval period to the MS;
setting the retrieval period in the MS;
registering the set retrieval period in the upper system; and
retrieving the paging channel in the MS as the MS transitions from a sleep state to an active state in the registered retrieval period.

10. The method of claim 9, wherein said setting the retrieval period comprises:
receiving a message in which a slot cycle index value corresponding to the retrieval period is stored from the upper system;
reporting receipt of the message to a user; and
setting the received slot cycle index value when a message input from the user indicates of change of a retrieval period of the paging channel.

11. The method of claim 10, wherein the slot cycle index value is stored in a certain field of an order message.

12. The method of claim, 9, wherein said registering the retrieval period comprises:
setting the slot cycle index value corresponding to the received retrieval period in the MS, and then reporting completion of the setting to the upper system; and
storing the slot cycle index value into a slot cycle index field of a retrieval period information table for the MS in the upper system.

13. The method of claim 7 or 9, wherein retrieving the paging channel comprises:
setting the slot cycle index value that is periodically transmitted to the MS from the upper system as a maximum value;
comparing the slot cycle index value received from the upper system with the set slot cycle index value, and choosing a smaller value; and
retrieving the slots of the paging channel in the retrieval period.

14. A method for increasing use time of a battery of a mobile station (MS) of a communication system, comprising:
identifying a plurality of mobile stations based on uses thereof; and
setting slot cycle index values of the mobile stations according to the uses.

15. The method of claim 14, wherein the slot cycle index value is a positive number of 0 to 7.

16. The method of claim 14, wherein said identifying the mobile stations comprises setting retrieval periods of the slots of the paging channel to different ones based on said uses.

17. The method of claim 16, wherein the retrieval period of the slots of the paging channels is changed according to the slot cycle index value of each mobile station.

18. The method of claim 14, wherein setting slot cycle index values further comprises: retrieving the slots of the paging channel in each mobile station according to a corresponding slot cycle index value.

19. The method of claim 18, wherein the slot cycle index value is included in an order message.
